(19) United States
(12) Patent Application Publication
(10) Pub. No.: US 2011/0157160 A1
(43) Pub. Date: Jun. 30, 2011

(54) Three-Dimensional Image Generating Device, Three-Dimensional Image Display Device, Three-Dimensional Image Generating Method, and Program

(76) Inventors: Suguru USHIKI, Tokyo (JP); Masami Ogata, Kanagawa (JP)

(21) Appl. No.: 12/960,021

(22) Filed: Dec. 3, 2010

(30) Foreign Application Priority Data
Dec. 28, 2009 (JP) P2009-297765

(51) Int. Cl. G06T 15/00

(52) U.S. Cl. 345/419

(57) ABSTRACT

Provided is a three-dimensional image generating device including: a depth setting portion configured to set a depth of each pixel or pixel group of a two-dimensional image, from which a stereoscopic view image is formed, from depth-degree information indicating a depth degree of each pixel or pixel group of the two-dimensional image; a coordinate calculating portion configured to calculate coordinates of a left eye image and a right eye image of a three-dimensional image on a display plane corresponding to each pixel or pixel group of the two-dimensional image from the depth and a distance from the display plane to a viewing position; and an image generating portion configured to generate the left eye image and the right eye image corresponding to the two-dimensional image according to the calculated coordinates.

### BACKGROUND OF THE INVENTION

1. Field of the Invention

The present invention relates to a three-dimensional image generating device, and more particularly, to a three-dimensional image generating device generating a three-dimensional (stereoscopic view) image from a two-dimensional (planar view) image, a three-dimensional image display device, and processing methods thereof, and a program allowing a computer to execute the methods.

2. Description of the Related Art

Recently, a display device capable of displaying not only two-dimensional images but also three-dimensional images has been proposed as a display device for displaying contents. In such a display device, a left eye image to be provided to the left eye and a right eye image to be provided to the right eye are displayed by using the binocular disparity occurring between the two eyes.

Such a three-dimensional image may be generated by independent cameras. However, if information on a binocular disparity or a sense of perspective may be used, a three-dimensional image may be spuriously generated based on a two-dimensional image. For example, there is disclosed a method of generating the left eye image and the right eye image by shifting a front image leftwards and rightwards according to the binocular disparity and the sense of perspective and overlapping the two shifted images with a background image (for example, Japanese Patent No. 3086577 (FIG. 2)).

### SUMMARY OF THE INVENTION

In the aforementioned related art, the three-dimensional image is spuriously generated by shifting the front image leftwards and rightwards. However, like the related art, if the front image is simply shifted, it is difficult to obtain a suitable stereoscopic effect. For example, in nature, an object existing at the foreground position is displayed to be larger. However, the object is not necessarily displayed in this manner, and an unnatural impression may be made on a viewer.

It is desirable to provide a suitable stereoscopic effect when a three-dimensional image is generated from a two-dimensional image.

According to a first embodiment of the invention, there is provided a three-dimensional image generating device including: a depth setting portion configured to set a depth of each pixel or pixel group of a two-dimensional image, from which a stereoscopic view image is formed, from depth-degree information indicating a depth degree of each pixel or pixel group of the two-dimensional image; a coordinate calculating portion configured to calculate coordinates of a left eye image and a right eye image of a three-dimensional image on a display plane corresponding to each pixel or pixel group of the two-dimensional image from the depth and a distance from the display plane to a viewing position; and an image generating portion configured to generate the left eye image and the right eye image corresponding to the two-dimensional image according to the calculated coordinates, a processing method of the device, and a program allowing a computer to execute the steps. Therefore, it is possible to obtain a function of generating a left eye image and a right eye image for providing a suitable stereoscopic effect according to a set depth.

In addition, in the first embodiment, the three-dimensional image generating device may further include an object area recognizing portion configured to recognize an object area in the two-dimensional image based on the two-dimensional image and the depth-degree information and generate coordinates of the center of the object area as a center coordinate, wherein the coordinate calculating portion may calculate the coordinates of the left eye image and the right eye image corresponding to each pixel and pixel group of the object area so that the stereoscopic view image is formed by magnifying the object area with respect to the center coordinate as a reference according to an allocated magnification ratio. Therefore, it is possible to obtain a function of emphasizing a stereoscopic effect while suppressing a disparity.

In addition, in the first embodiment, the coordinate calculating portion may include: a shift amount calculating portion configured to calculate shift amounts of the left eye image and the right eye image in the X coordinate and the Y coordinate with respect to the two-dimensional image; and a coordinate position calculating portion configured to calculate coordinate positions in the X coordinate and Y coordinate based on the shift amount. Therefore, it is possible to obtain a function of calculating a coordinate position of the X coordinate and the Y coordinate based on the shift amounts of the X coordinate and the Y coordinate.

In addition, in the first embodiment, the depth setting portion may set a value increased or decreased by an allocated depth offset in proportion to an allocated depth emphasizing level as the depth. Therefore, it is possible to obtain a function of setting the depth according to the viewer's preference.

In addition, according to a second embodiment of the invention, there is provided a three-dimensional image display device including: a depth setting portion configured to set a depth of each pixel or pixel group of a two-dimensional image, from which a stereoscopic view image is formed, from depth-degree information indicating a depth degree of each pixel or pixel group of the two-dimensional image; a coordinate calculating portion configured to calculate coordinates of a left eye image and a right eye image of a three-dimensional image on a display plane corresponding to each pixel or pixel group of the two-dimensional image from the depth and a distance from the display plane to a viewing position; an image generating portion configured to generate the left eye image and the right eye image corresponding to the two-dimensional image according to the calculated coordinates; and an image display portion configured to display a three-dimensional image using the left eye image and the right eye image. Therefore, it is possible to obtain a function of generating and displaying the left eye image and the right eye image for providing a suitable stereoscopic effect according to the set depth.

According to the invention, it is possible to obtain a superior effect in providing a suitable stereoscopic effect when a three-dimensional image is generated from a two-dimensional image.

### BRIEF DESCRIPTION OF THE DRAWINGS

FIG. 1 is a diagram illustrating an example of a configuration of a three-dimensional image display system according to an embodiment of the invention.

FIG. 2 is a diagram illustrating an example of a configuration of a three-dimensional image generating device according to a first embodiment of the invention.

FIG. 3 is a diagram illustrating an example of a functional configuration of the three-dimensional image generating device according to the first embodiment of the invention.

FIG. 4 is a diagram illustrating an example of a functional configuration of a right eye coordinate calculating portion according to the first embodiment of the invention.

FIG. 5 is a diagram illustrating schematic operations of the three-dimensional image generating device according to the first embodiment of the invention.

FIG. 6 is a diagram illustrating a situation where a stereoscopic view image of an object is formed by operations of the three-dimensional image generating device according to the first embodiment of the invention.

FIG. 7 is a diagram illustrating a situation where a stereoscopic view image is formed in the case where a depth is set to be short in the three-dimensional image generating device according to the first embodiment of the invention.

FIG. 8 is a diagram illustrating a situation where stereoscopic view images of objects are formed by operations of the three-dimensional image generating device according to the first embodiment of the invention.

FIG. 9 is a top view illustrating a method of calculating X coordinates of a left eye image and a right eye image according to the first embodiment of the invention.

FIG. 10 is a top view illustrating a method of calculating X coordinates of a left eye image according to the first embodiment of the invention.

FIG. 11 is a top view illustrating a method of calculating X coordinates of a right eye image according to the first embodiment of the invention.

FIG. 12 is a side view illustrating a method of calculating Y coordinates of a left eye image and a right eye image according to the first embodiment of the invention.

FIGS. 13A and 13B are diagrams illustrating a relationship between depth-degree information and a depth according to the first embodiment of the invention.

FIGS. 14A and 14B are other diagrams illustrating a relationship between depth-degree information and a depth according to the first embodiment of the invention.

FIG. 15 is still another diagram illustrating a relationship between depth-degree information and a depth according to the first embodiment of the invention.

FIG. 16 is a diagram illustrating an example of a pixel position of a two-dimensional image according to the first embodiment of the invention.

FIG. 17 is a diagram illustrating an example of a processing procedure of right eye image generating process in the three-dimensional image generating device according to the first embodiment of the invention.

FIGS. 18A and 18B are diagrams illustrating an example of a right eye coordinate calculating process according to the first embodiment of the invention.

FIG. 19 is a diagram illustrating an example of a processing procedure of a right eye image updated pixel determining process in the three-dimensional image generating device according to the first embodiment of the invention.

FIGS. 20A and 20B are diagrams illustrating an example of candidates for an updated pixel determining process according to the first embodiment of the invention.

FIGS. 21A to 21C are diagrams illustrating an example of a write completion determination process according to the first embodiment of the invention.

FIGS. 22A to 22D are diagrams illustrating an example of a priority determination process according to the first embodiment of the invention.

FIGS. 23A to 23C are diagrams illustrating an example of a determination data updating process according to the first embodiment of the invention.

FIGS. 24A and 24B are diagrams illustrating an example of a right eye image updating process according to the first embodiment of the invention.

FIG. 25 is a diagram illustrating an example of a processing procedure of a left eye image generating process in the three-dimensional image generating device according to the first embodiment of the invention.

FIG. 26 is a diagram collectively illustrating the situations of the stereoscopic view generated according to the first embodiment of the invention.

FIG. 27 is a diagram illustrating an example of a functional configuration of a three-dimensional image generating device according to a second embodiment of the invention.

FIGS. 28A and 28B are diagrams illustrating an example of a right eye coordinate calculating process according to the second embodiment of the invention.

FIG. 29 is a top view illustrating a method of calculating X coordinates of a left eye image and a right eye image according to the second embodiment of the invention.

FIG. 30 is a top view illustrating a method of calculating X coordinates of a right eye image according to the second embodiment of the invention.

FIG. 31 is another top view illustrating a method of calculating X coordinates of a right eye image according to the second embodiment of the invention.

FIG. 32 is a diagram illustrating a method of calculating Y coordinates of a left eye image and a right eye image according to the second embodiment of the invention.

FIG. 33 is a diagram collectively illustrating the situations of the stereoscopic view generated according to the second embodiment of the invention.

### DESCRIPTION OF THE PREFERRED EMBODIMENTS

Hereinafter, embodiments for implementing the invention (hereinafter, referred to as an embodiment) will be described. The description is made in the following order.

1. First Embodiment (Example of Controlling Stereoscopic Effect so as to Maintain Size Homeostasis)

2. Second Embodiment (Example of Control to Emphasize Stereoscopic Effect)

### 1. First Embodiment

### [Example of Configuration of Three-Dimensional Image Display System]

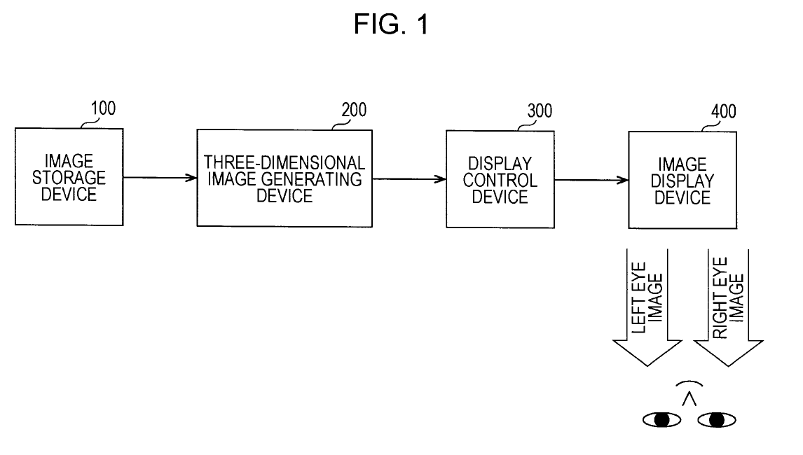

FIG. 1 is a diagram illustrating an example of a configuration of a three-dimensional image display system according to an embodiment of the invention. The three-dimensional image display system includes an image storage device 100, a three-dimensional image generating device 200, a display control device 300, and an image display device 400.

The image storage device 100 stores image data for three-dimensional (stereoscopic view) display in correspondence with information on a two-dimensional (planar view) image and a depth degree (depth) of the two-dimensional image. Herein, the image data may be a still image or may be a moving picture.

The three-dimensional image generating device 200 generates the three-dimensional image configured with a right eye image and a left eye image based on the two-dimensional image and the depth-degree information stored in the image storage device 100.

The display control device 300 control displaying so that the image data output from the three-dimensional image generating device 200 are displayed on the image display device 400. The image display device 400 is a stereoscopic display which displays the image data as the three-dimensional image. As a stereoscopic display method, an arbitrary method such as a method of alternately arranging left and right images in each scan line or a method of displaying the left and right images in a time division manner may be applied. The display control device 300 performs the display control so as to correspond to the display method of the image display device 400. In addition, the image display device 400 is an example of an image display portion disclosed in the Claims.

### [Example of Configuration of Three-Dimensional Image Generating Device 200]

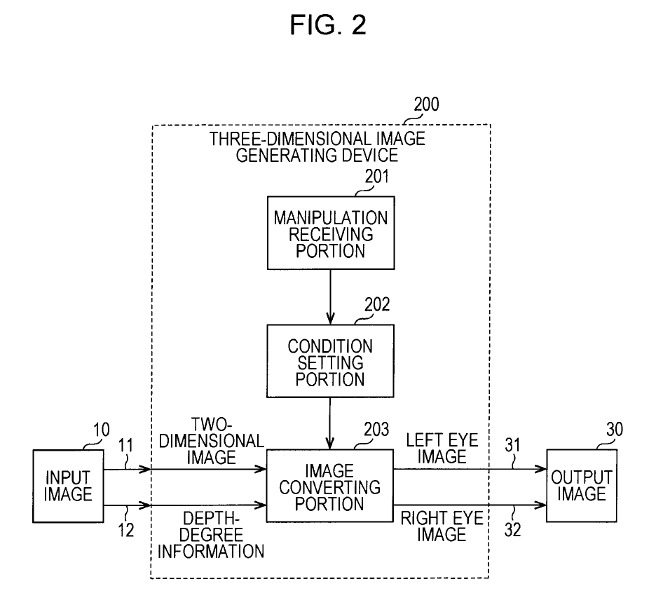

FIG. 2 is a diagram illustrating an example of a configuration of a three-dimensional image generating device 200 according to the first embodiment of the invention. The three-dimensional image generating device 200 receives the two-dimensional image 11 and the depth-degree information 12 as an input image 10 and outputs the three-dimensional image configured with a left eye image 31 and a right eye image 32 as an output image 30. Herein, the depth-degree information 12 indicates a depth degree of each pixel of the two-dimensional image 11 in a one-to-one correspondence manner. However, the depth-degree information 12 may indicate a depth degree of each pixel group with a coarser grain size. The three-dimensional image generating device 200 includes a manipulation receiving portion 201, a condition setting portion 202, and an image converting portion 203.

The manipulation receiving portion 201 is a user interface for receiving manipulation input from a user. As the manipulation input, a later-described depth emphasizing level, a depth emphasizing offset, a display size, or the like is considered.

The condition setting portion 202 sets conditions for three-dimensional image generation of the image converting portion 203 according to the manipulation input received from the manipulation receiving portion 201.

The image converting portion 203 performs image conversion on the input image 10 according to the conditions set by the condition setting portion 202 and outputs the output image 30 which is a three-dimensional image.

### [Example of Functional Configuration of Three-Dimensional Image Generating Device 200]

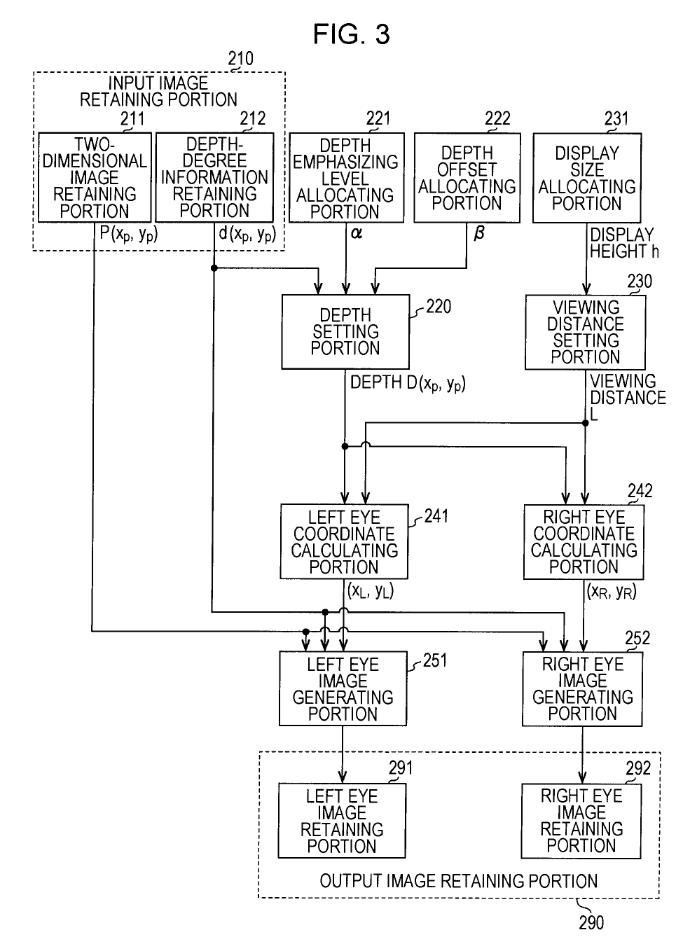

FIG. 3 is a diagram illustrating an example of a functional configuration of the three-dimensional image generating device 200 according to the first embodiment of the invention. The three-dimensional image generating device 200 includes an input image retaining portion 210, a depth setting portion 220, a depth emphasizing level allocating portion 221, a depth offset allocating portion 222, a viewing distance setting portion 230, and a display size allocating portion 231. In addition, the three-dimensional image generating device 200 includes a left eye coordinate calculating portion 241, a right eye coordinate calculating portion 242, a left eye image generating portion 251, a right eye image generating portion 252, and an output image retaining portion 290. The depth emphasizing level allocating portion 221, the depth offset allocating portion 222, and the display size allocating portion 231 are implemented by the manipulation receiving portion 201. The depth setting portion 220 and the viewing distance setting portion 230 are implemented by the condition setting portion 202. The left eye coordinate calculating portion 241, the right eye coordinate calculating portion 242, the left eye image generating portion 251, and the right eye image generating portion 252 are implemented by the image converting portion 203.

The input image retaining portion 210 retains the input image 10. The input image retaining portion 210 includes a two-dimensional image retaining portion 211 retaining the two-dimensional image 11 and a depth-degree information retaining portion 212 retaining the depth-degree information 12. Hereinafter, each pixel value of the two-dimensional image 11 is represented by P(xₚ, yₚ), and each value of the depth-degree information 12 is represented by d(xₚ, yₚ). However, the xₚ represents a value of the X coordinate of an observed pixel, and the yₚ represents a value of the Y coordinate of the observed pixel.

The depth setting portion 220 sets a depth from a display plane based on the depth-degree information 12 retained in the depth-degree information retaining portion 212. If seen from the user (viewer) side, it appears that the observed pixel exists at a position with this depth. In the case of the viewer side from the display plane, the depth becomes a positive value, and in the case of the opposite side, the depth becomes a negative value, so that any one of the values may be allowable. Accordingly, the stereoscopic view image may be formed so as to protrude from the display plane forwards, and the stereoscopic view image may be formed so as to recede from the display plane inwards. The depth is set according to user's preference by a depth emphasizing level α allocated by the depth emphasizing level allocating portion 221 or a depth offset β allocated by the depth offset allocating portion 222. For example, in the case of using only the depth emphasizing level α, the depth D(xₚ, yₚ) is expressed by the following equation.

D(xₚ, yₚ)=α×d(xₚ, yₚ) Equation 1

In addition, in the case of using both of the depth emphasizing level α and the depth offset β, the depth D(xₚ, yₚ) is expressed by the following equation.

D(xₚ, yₚ)=α×d(xₚ, yₚ)+β Equation 2

In this manner, the depth emphasizing level α or the depth offset β may be allocated so as to perform three-dimensional display at the position according to the user's preference.

The viewing distance setting portion 230 sets a viewing distance L from the display plane to the both eyes of the viewer. Herein, it is considered that three times the display height h is set as the viewing distance L, as generally considered to be the optimal distance. The display size allocating portion 231 allocates display vertical and horizontal display sizes of the display plane, and the viewing distance L may be obtained by setting the vertical size of the display plane allocated in the display size allocating portion 231 as the display height h.

The left eye coordinate calculating portion 241 calculates the coordinate (x_{L}, y_{L}) of the left eye image on the display plane. The right eye coordinate calculating portion 242 calculates the coordinate (x_{R}, y_{R}) of the right eye image on the display plane. The left eye coordinate calculating portion 241 and the right eye coordinate calculating portion 242 calculates the coordinate of the observed pixel of the right eye image or the left eye image based on the depth D(xₚ, yₚ) set by the depth setting portion 220 and the viewing distance L set by the viewing distance setting portion 230. In addition, the left eye coordinate calculating portion 241 or the right eye coordinate calculating portion 242 is an example of a coordinate calculating portion disclosed in the Claims. The detailed coordinate calculating methods of the left eye coordinate calculating portion 241 and the right eye coordinate calculating portion 242 will be described later.

The left eye image generating portion 251 generates the left eye image by shifting the observed pixel P(xₚ, yₚ) of the two-dimensional image 11 retained in the two-dimensional image retaining portion 211 to the coordinate (x_{L}, y_{L}) calculated by the left eye coordinate calculating portion 241. The right eye image generating portion 252 generates the right eye image by shifting the observed pixel P(xₚ, yₚ) of the two-dimensional image 11 retained in the two-dimensional image retaining portion 211 to the coordinate (x_{R}, y_{R}) calculated by the right eye coordinate calculating portion 242. In addition, in the left eye image generating portion 251 and the right eye image generating portion 252, the image generation may be performed at high accuracy with reference to the depth-degree information 12 retained in the depth-degree information retaining portion 212. The details of the image generation will be described later. In addition, the left eye image generating portion 251 or the right eye image generating portion 252 is an example of an image generating portion disclosed in the Claims.

The output image retaining portion 290 retains the output image 30 and includes a left eye image retaining portion 291 retaining the left eye image 31 and a right eye image retaining portion 292 retaining the right eye image 32.

In the three-dimensional image generating device 200, the observed pixel is sequentially updated. For example, in the two-dimensional image, the observed pixel is sequentially updated in the direction from the upper left pixel toward the right side, and the observed pixel is sequentially updated again from the left pixel in the one lower row following the pixel at the right end toward the right side. Although not shown, each component of the three-dimensional image generating device 200 is appropriately provided with the coordinate (xₚ, yₚ) of the observed pixel.

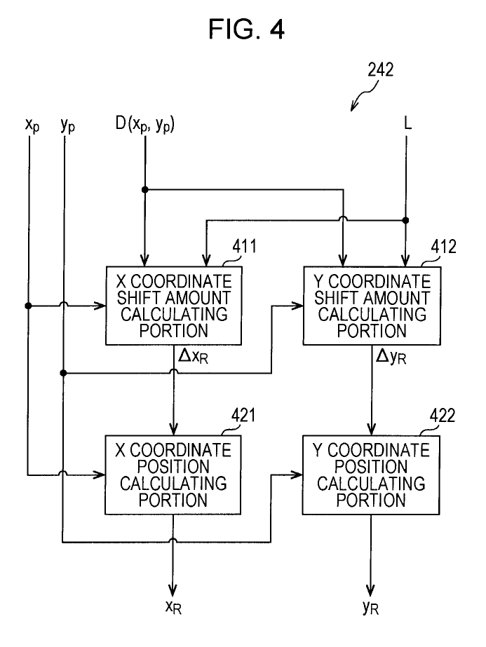

FIG. 4 is a diagram illustrating an example of a functional configuration of the right eye coordinate calculating portion 242 according to the first embodiment of the invention. The right eye coordinate calculating portion 242 includes an X coordinate shift amount calculating portion 411, a Y coordinate shift amount calculating portion 412, an X coordinate position calculating portion 421, and a Y coordinate position calculating portion 422.

The X coordinate shift amount calculating portion 411 calculates an X-directional shift amount Δx_{R} of the observed pixel P(xₚ, yₚ) of the right eye image based on the depth D(xₚ, yₚ) set by the depth setting portion 220 and the viewing distance L set by the viewing distance setting portion 230. The Y coordinate shift amount calculating portion 412 calculates a Y-directional shift amount Δy_{R} of the observed pixel P(xₚ, yₚ) of the right eye image based on the depth D(xₚ, yₚ) set by the depth setting portion 220 and the viewing distance L set by the viewing distance setting portion 230. In addition, the X coordinate shift amount calculating portion 411 or the Y coordinate shift amount calculating portion 412 is an example of a shift amount calculating portion disclosed in the Claims.

The X coordinate position calculating portion 421 calculates an X coordinate position x_{R} of the observed pixel on the right eye image by adding the shift amount Δx_{R} calculated by the X coordinate shift amount calculating portion 411 to the X coordinate xₚ of the observed pixel P(xₚ, yₚ). The Y coordinate position calculating portion 422 calculates a Y coordinate position y_{R} of the observed pixel on the right eye image by adding the shift amount Δy_{R} calculated by the Y coordinate shift amount calculating portion 412 to the Y coordinate yₚ of the observed pixel P(xₚ, yₚ). In addition, the X coordinate position calculating portion 421 or the Y coordinate position calculating portion 422 is an example of a coordinate position calculating portion disclosed in the Claims.

The X coordinate position x_{R} and the Y coordinate position y_{R} of the right eye image calculated by the right eye coordinate calculating portion 242 are supplied to the right eye image generating portion 252.

In addition, herein, although an example of the configuration of the right eye coordinate calculating portion 242 is described, since the left eye coordinate calculating portion 241 calculating the X coordinate position x_{L} and the Y coordinate position y_{L} in the left eye image also has the same configuration, detailed description of the example of the configuration of the left eye coordinate calculating portion 241 is omitted.

### [Schematic Operations of Three-Dimensional Image Generating Device 200]

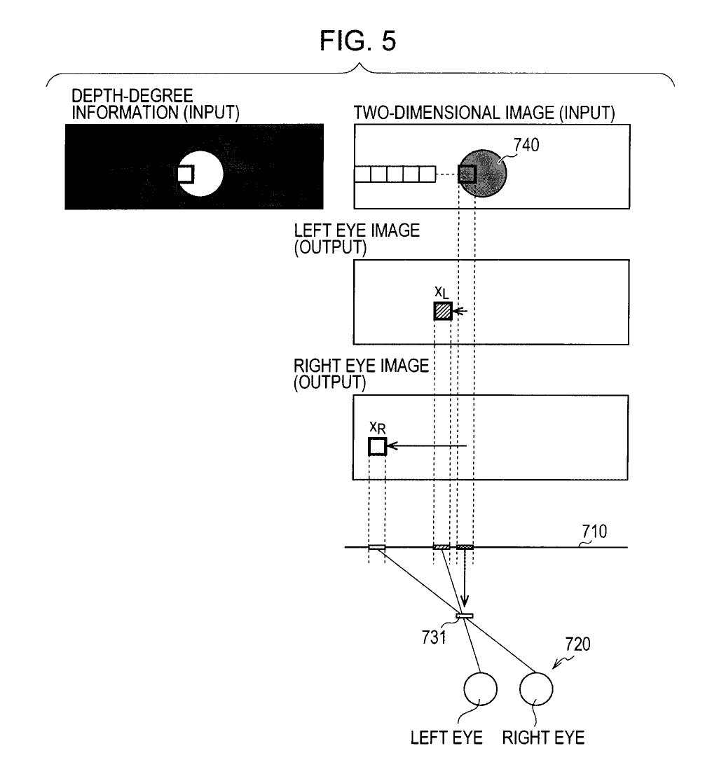

FIG. 5 is a diagram illustrating schematic operations of the three-dimensional image generating device 200 according to the first embodiment of the invention. The three-dimensional image generating device 200, for example, initially sets the upper left pixel as the observed pixel in the two-dimensional image and sequentially updates the observed pixel toward the right side. The observed pixel is sequentially updated again from the left pixel in the one lower row following the pixel at the right end toward the right side. In this example, the depth-degree information corresponds to each pixel of the two-dimensional image in the one-to-one correspondence manner, so that the depth-degree information indicates the depth degree of each pixel of the two-dimensional image.

This figure illustrates the situation when the observed pixel is sequentially updated from the pixel of the left side toward the right side to reach the position of the object 740. At this time, the pixel position 711 on the display plane 710 with respect to the observed pixel seems to exist at the position 731 protruding in the vertical direction based on the depth-degree information, as seen from the two eyes 720. In this case, the position 731 seen from the left eye is projected on the coordinate x_{L} of the left eye image. In addition, the position 731 seen from the right eye is projected on the coordinate x_{R} of the right eye image. This process is repeatedly performed on the all pixels of the two-dimensional image, so that the stereoscopic view image of the object 740 may be formed.

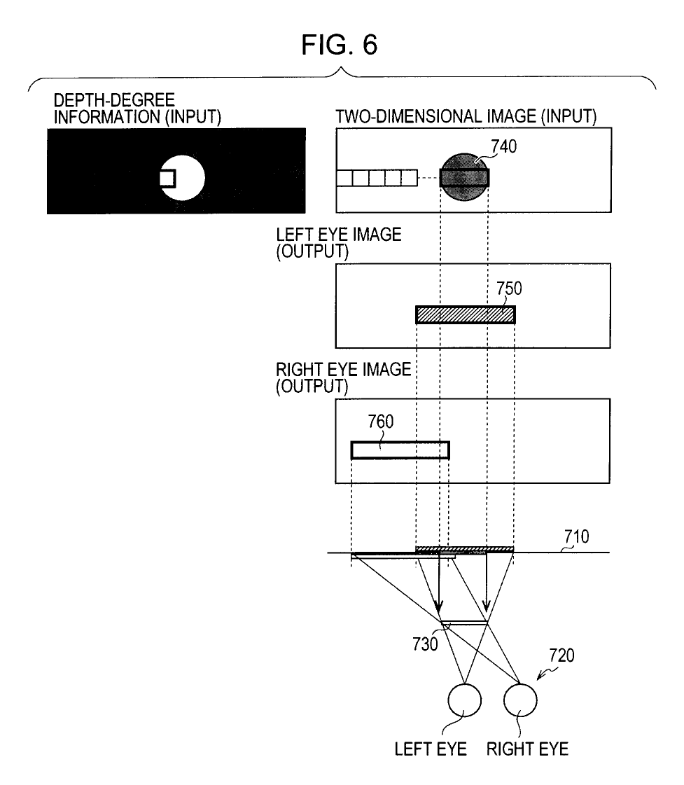

FIG. 6 is a diagram illustrating a situation where a stereoscopic view image of an object 740 is formed by operations of the three-dimensional image generating device 200 according to the first embodiment of the invention. By repeating the process illustrated in FIG. 5, the stereoscopic view image 730 of the entire object 740 is formed at the position protruding in the vertical direction based on the depth-degree information. In other words, the stereoscopic view image 730 seen from the left eye is projected on the image 750 of the left eye image. In addition, the stereoscopic view image 730 seen from the right eye is projected on the image 760 of the right eye image.

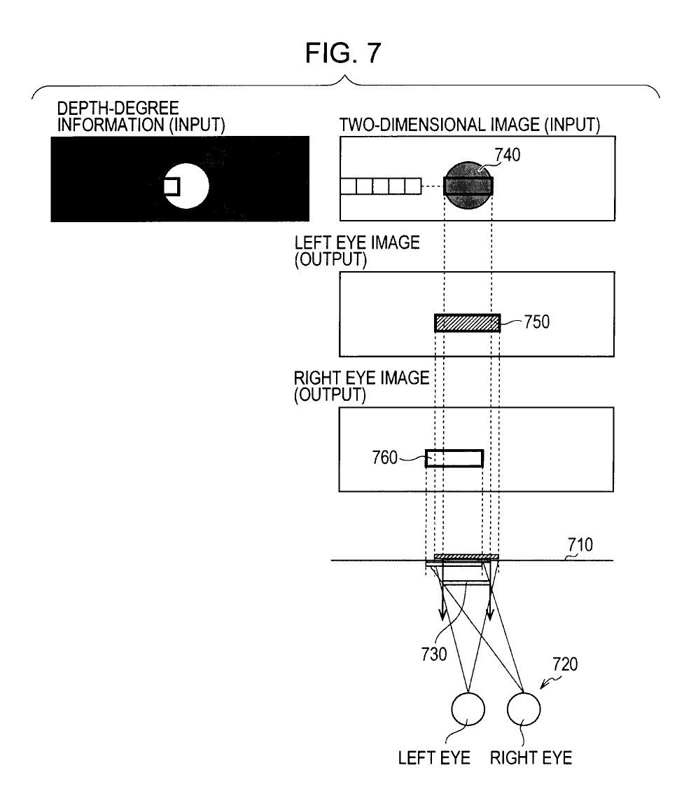

FIG. 7 is a diagram illustrating a situation where a stereoscopic view image is formed in the case where a depth is set to be short in the three-dimensional image generating device 200 according to the first embodiment of the invention. In the example of FIG. 7, the depth D is set to be shorter than that of the case of FIG. 6. However, herein, it should be noted that the size of the object 740 is also maintained in the stereoscopic view image 730. In other words, in the first embodiment of the invention, the object in the two-dimensional image is controlled to protrude or recede in the vertical direction in the state where the “size homeostasis” is secured.

Herein, the size homeostasis is a well-known phenomenon when the apparent size of an object remains almost constant although a size of a retinal image is changed according to a change in an observation distance of the object. In other words, with respect to objects having the same size, the foreground object is projected to be large in the retinal image, and the background object is projected to be small in the retinal image. Therefore, in order to reproduce the “size homeostasis”, in the three-dimensional display, it is necessary to display the image to be larger for the foreground object and to be smaller for the background object. According to the first embodiment of the invention, it is possible to secure the “size homeostasis”.

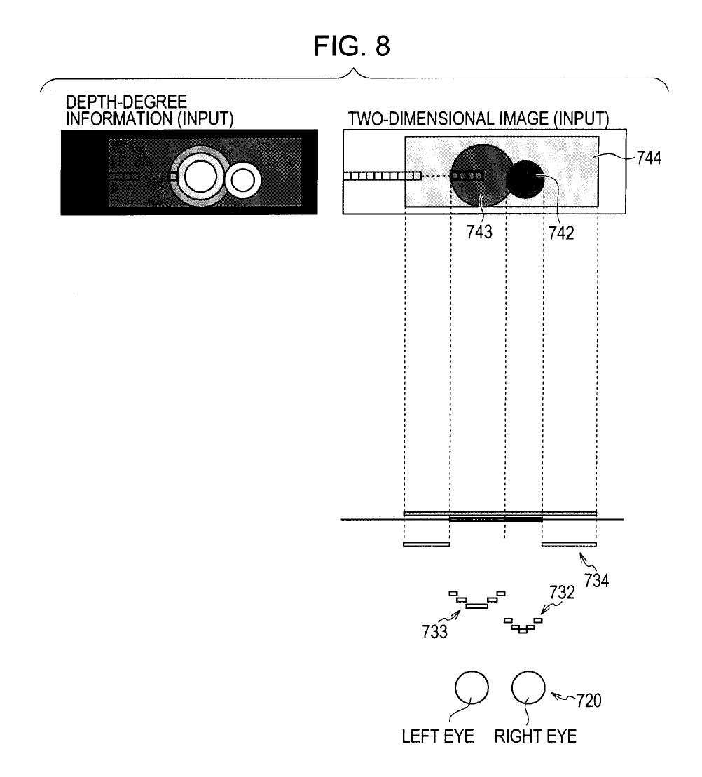

FIG. 8 is a diagram illustrating a situation where stereoscopic view images of objects 742 to 744 is formed by operations of the three-dimensional image generating device 200 according to the first embodiment of the invention. In the example of FIG. 6, although the depth-degree information is set as two steps for simplicity of the description, it is considered that, in the example, the depth-degree information has a multi-step gradation. Therefore, stereoscopic view images 732 to 734 are formed with respect to objects 742 to 744.

### [Method of Calculating Left Eye Coordinate and Right Eye Coordinate]

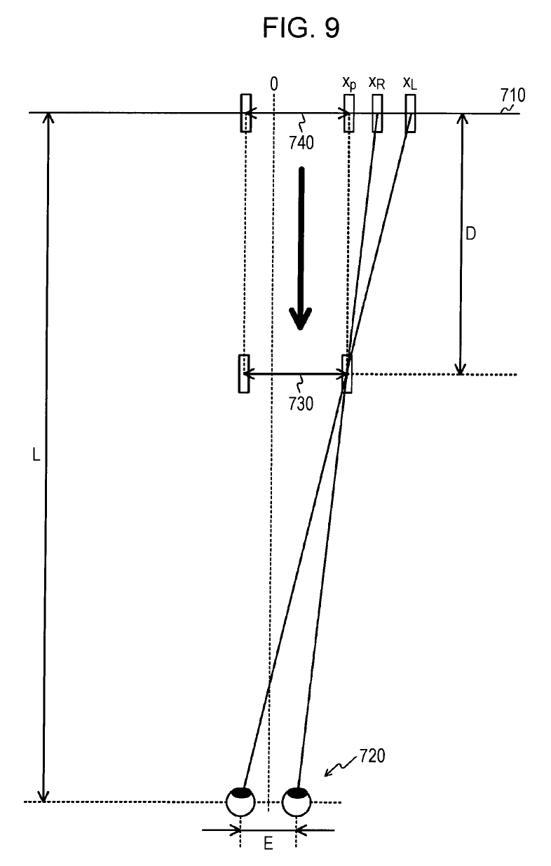

FIG. 9 is a top view illustrating a method of calculating X coordinates of a left eye image and a right eye image according to the first embodiment of the invention. Herein, it is assumed that the two eyes 720 are located at the position of the viewing distance L from the display plane 710. The viewing distance L is set to a value which is three times the display height h by the viewing distance setting portion 230. For the eye distance E, for example, 65 mm may be used as a standard value. In addition, the depth D(xₚ, yₚ) from the display plane 710 may be obtained from the aforementioned Equation 1 or 2 by the depth setting portion 220. Therefore, in the viewing distance L, the object 740 is recognized as the stereoscopic view image 730 at the position which protrudes in the vertical direction with the depth D(xₚ, yₚ). In other words, the size of the stereoscopic view image 730 is equal to the size of the object 740.

Hereinafter, a transformation equation of the case where a corner of the object 740 is set as the observed pixel (xₚ, yₚ) and the X coordinate xₚ is transformed into the coordinate x_{L} on the left eye image and the coordinate x_{R} on the right eye image is described.

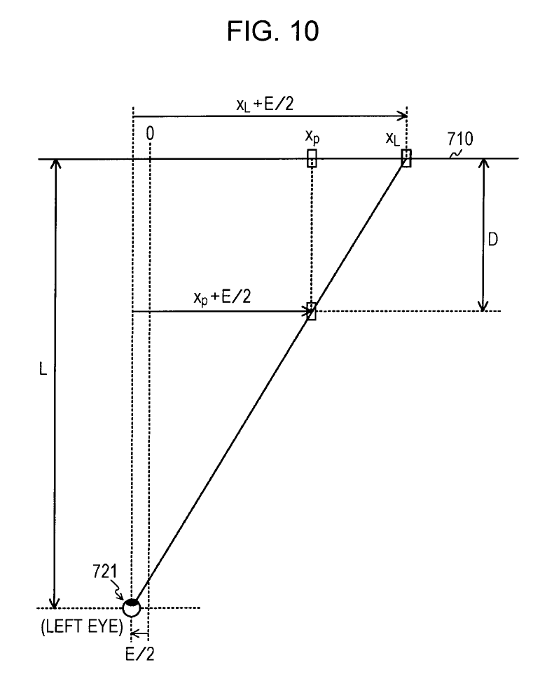

FIG. 10 is a top view illustrating a method of calculating X coordinates of a left eye image according to the first embodiment of the invention. If auxiliary lines extending from the centers of the two eyes in the vertical direction with respect to the display plane are considered, the following equation is satisfied for a triangle defined by the X coordinate x_{L} of the left eye image corresponding to the X coordinate xₚ of the observed pixel and the left eye 721.

L:(x_{L}+E/2)=(L−D):(xₚ+E/2)

If the above equation is solved with respect to the x_{L}, the following equation is obtained.

x_{L}=(L/(L−D))·xₚ+(E·D)/(2·(L−D)) Equation 3

In addition, if the above equation is modified to be expressed in a form of separating the shift amount, the following equation is obtained.

x_{K}=xₚ+Δx_{L}

Δx_{L}=(D/(L−D))·xₚ+(E·D)/(2·(L−D))

As understood from the above equation, the shift amount Δx_{L} includes a term of the X coordinate xₚ of the observed pixel. In other words, it may be understood that the transformation is smoothly performed according to the observed pixel. On the contrary, like the related art, in the case where the image is simply shifted leftwards and rightwards, the transformation is performed irrespective of the observed pixel.

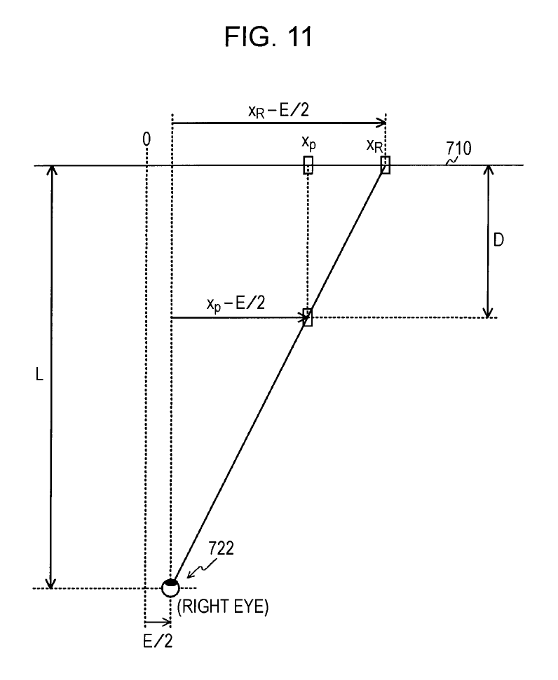

FIG. 11 is a top view illustrating a method of calculating X coordinates of a right eye image according to the first embodiment of the invention. If auxiliary lines extending from the centers of the two eyes in the vertical direction with respect to the display plane are considered, the following equation is satisfied for a triangle defined by the X coordinate x_{R} of the right eye image corresponding to the X coordinate xₚ of the observed pixel and the right eye 722.

L:(x_{R}−E/2)=(L−D):(xₚ−E/2)

If the above equation is solved with respect to the x_{R}, the following equation is obtained.

x_{R}=(L/(L−D))·xₚ−(E·D)/(2·(L−D)) Equation 4

In addition, if the above equation is modified to be expressed in a form of separating the shift amount, the following equation is obtained.

x_{R}=xₚ+Δx_{R}

Δx_{R}=(D/(L−D))·xₚ−(E·D)/(2·(L−D))

The shift amount Δx_{R} is calculated by the aforementioned X coordinate shift amount calculating portion 411.

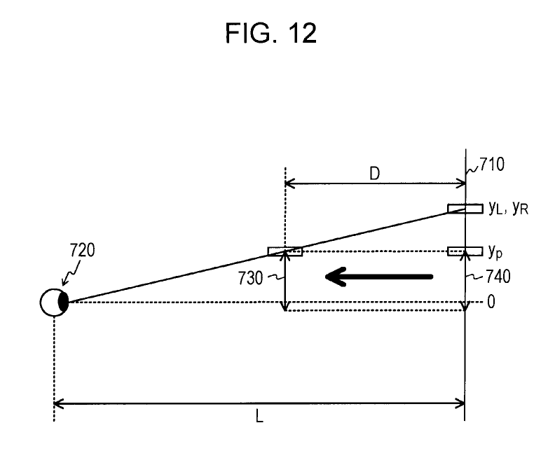

FIG. 12 is a side view illustrating a method of calculating Y coordinates of a left eye image and a right eye image according to the first embodiment of the invention. The same viewing distance L or depth D(xₚ, yₚ) is used as that of the case of calculating the X coordinate. In other words, in the viewing distance L, the object 740 is recognized as the stereoscopic view image 730 at the position which protrudes in the vertical direction with the depth D(xₚ, yₚ).

Hereinafter, a transformation equation of the case where a corner of the object 740 is set as the observed pixel (xₚ, yₚ) and the Y coordinate yₚ is transformed into the coordinate y_{L} on the left eye image and the coordinate y_{R} on the right eye image is described. However, unlike the X coordinate, since the Y coordinates of the left eye image and the right eye image are coincident with each other, the description is made on the coordinate y_{R} of the right eye image.

If auxiliary lines extending from the centers of the two eyes in the vertical direction with respect to the display plane are considered, the following equation is satisfied for a triangle defined by the Y coordinate y_{R} of the right eye image corresponding to the Y coordinate yₚ of the observed pixel and the two eyes 720.

L:y_{R}=(L−D) :yₚ

If the above equation is solved with respect to the y_{R}, the following equation is obtained.

y_{R}=yₚ·L/(L−D) Equation 5

In addition, if the above equation is modified to be expressed in a form of separating the shift amount, the following equation is obtained.

y_{R}=yₚ+Δy_{R}

Δy_{R}=yₚ·D/(L−D)

As described above, since the y_{R} is equal to the y_{L}, the following equation is also satisfied similarly.

y_{L}=yₚ·L/(L−D) Equation 6

y_{L}=yₚ+Δy_{L}

Δy_{L}=yₚ·D/(L−D)

In addition, like the related art, in the case where the image is simply shifted leftwards and rightwards, the shift amount of the Y coordinate is not considered as a target of the process. It may be understood from this point that, according to the embodiment of the invention, a smooth process is performed by taking into consideration the shift amount in the Y coordinate direction.

### [Relationship Between Depth-Degree Information d and Depth D]

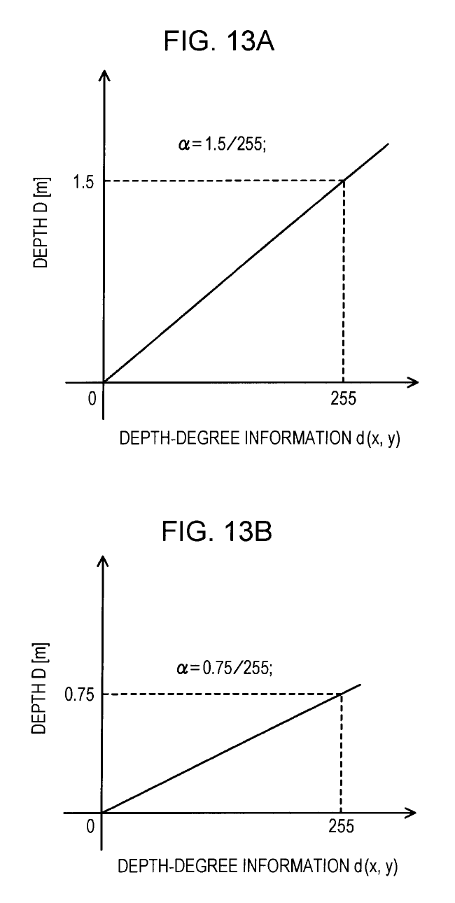

FIGS. 13A and 13B are diagrams illustrating a relationship between depth-degree information d and a depth D according to the first embodiment of the invention. This example represents influence of the case where the depth emphasizing level α is changed in the aforementioned Equation 1. In any one of FIGS. 13A and 13B, the depth-degree information is configured to indicate any one of the values of “0” to “255”.

FIG. 13A is an example of the case where, when the depth-degree information is the maximum value “255”, the depth emphasizing level α is set so that the depth D is “1.5 m”. On the other hand, FIG. 13B is an example of the case where, when the depth-degree information is the maximum value “255”, the depth emphasizing level α is set so that the depth D is “0.75 m”. As understood from the comparison of the two examples, if the depth emphasizing level α is changed, the slope of the depth to the depth-degree information is changed. Accordingly, in the case where the depth is desired to be emphasized, the depth emphasizing level α may be set to be large.

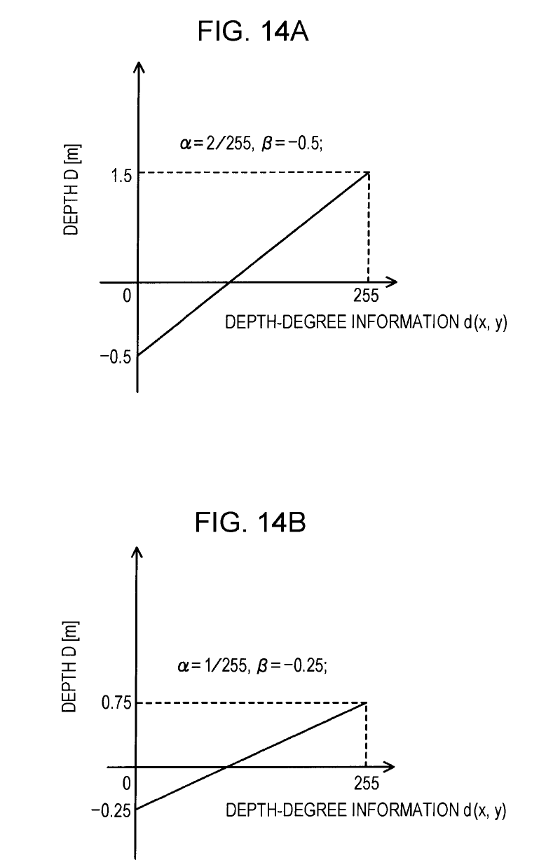

FIGS. 14A and 14B are other diagrams illustrating a relationship between depth-degree information d and a depth D according to the first embodiment of the invention. This example represents influence of the case where the depth emphasizing level α and the depth offset β are changed in the aforementioned Equation 2. Similarly to FIGS. 13A and 13B, in any one of FIGS. 14A and 14B, the depth-degree information is also configured to indicate any one of the values of “0” to “255”.

FIG. 14A is an example where the depth emphasizing level α and the depth offset β are set so that the depth D is “1.5 m” when the depth-degree information is the maximum value “255” and the depth D is “−0.5 m” when the depth-degree information is the minimum value “0”. As described above, when the depth D becomes a negative value, the object is seen to recede from the viewer at the side further inward than the display plane.

On the other hand, FIG. 14B is an example where the depth emphasizing level α and the depth offset β are set so that the depth D is “0.75 m” when the depth-degree information is the maximum value “255” and the depth D is “−0.25 m” when the depth-degree information is the minimum value “0”.

As understood from the comparison of the two examples, if the depth emphasizing level α is changed, the slope of the depth with respect to the depth-degree information is changed, and if the depth offset β is changed, the depth is entirely shifted. A user may perform reproducing and displaying of a three-dimensional image having a stereoscopic effect suitable for the user's preference by allocating the depth emphasizing level α or the depth offset β according to the user's preference. In addition, the depth emphasizing level α and the depth offset β may be allocated with specific values by the user, and the depth emphasizing level α and the depth offset β may be allocated with three preset steps of, for example, weak, medium, and strong steps.

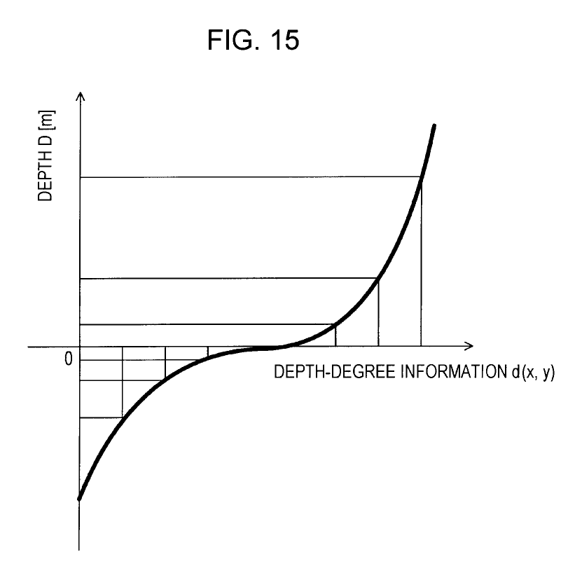

FIG. 15 is still another diagram illustrating a relationship between depth-degree information d and a depth D according to the first embodiment of the invention. Although the example where the set depth D is proportional to the depth-degree information d is described in aforementioned FIGS. 13A, 13B, 14A, and 14B, the invention is not limited thereto. As an example, FIG. 15 illustrates an aspect where the relationship between the depth-degree information d and the depth D is nonlinear. Due to such nonlinearity, it is possible to improve resolution in the vicinity of the display plane 710.

### [Example of Operation of Coordinate Calculation and Image Generation]

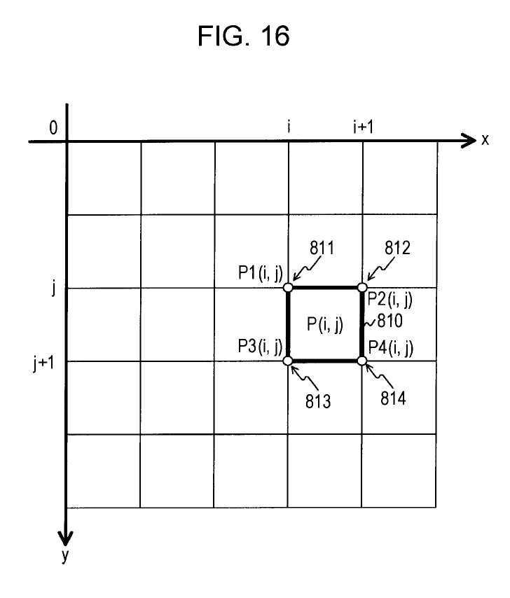

FIG. 16 is a diagram illustrating an example of a pixel position of a two-dimensional image 11 according to the first embodiment of the invention. Herein, the upper left point of the two-dimensional image 11 is set as the origin, and an i-th column, j-th row pixel 810 is denoted by P(i, j). The pixel 810 becomes a before-transformation reference pixel of the two-dimensional image 11. Similarly, the elements of the depth-degree information 12 corresponding to each pixel of the two-dimensional image 11 are denoted by d(i, j). In addition, the coordinate 811 of the upper left position of the pixel P(i, j) is denoted by P1(i, j); the coordinate 812 of the upper right position thereof is denoted by P2(i, j); the coordinate 813 of the lower left position thereof is denoted by P3(i, j); and the coordinate 814 of the lower right position thereof is denoted by P4 (i, j).

Herein, the X coordinate of the P1(i, j) is denoted by s_{P1(i, j)}, and the Y coordinate thereof is denoted by y_{P1(i, j)}. With respect to the other pixels P2(i, j), P3(i, j), and P4 (i, j), the same notation is applied. In this case, the following Equations are defined.

x_{P1(i, j)}=x_{P3(i, j)}=i

x_{P2(i, j)}=x_{P4(i, j)}=i+1

y_{P1(i, j)}=y_{P2(i, j)}=j

y_{P3(i, j)}=y_{P4(i, j)}=j+1

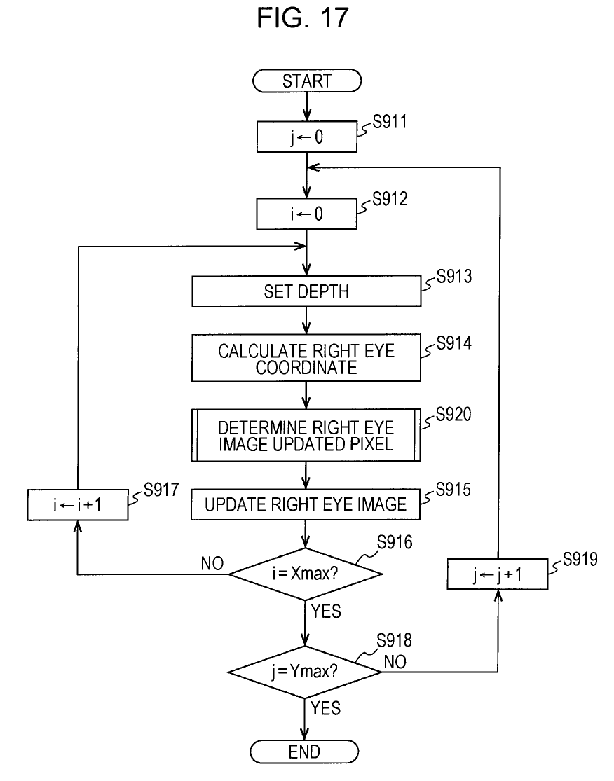

FIG. 17 is a diagram illustrating an example of a right eye image generating processing procedure in the three-dimensional image generating device 200 according to the first embodiment of the invention. As described above, the upper left position of the two-dimensional image 11 is set as the origin, and the observed pixel is updated from the upper left position toward the right side. If the process up to the pixel at the right end is ended, the process is performed by setting the pixel at the left end of the next row as the observed pixel. The control of variables for the process is performed in Steps S911, S912, S917, and S919. In other words, in Step S911, the variable j of the Y coordinate is reset to “0”. In addition, Step S912, the variable i of the X coordinate is reset to “0”. Next, in Step S917 of the inner side loop, the variable i of the X coordinate is added by “1”. In addition, in Step S919 of the outer side loop, variable j of the Y coordinate is added by “1”.

In the inner side loop, the depth D(i, j) of the observed pixel (i, j) is set by the depth setting portion 220 (Step S913). Next, in the right eye coordinate calculating portion 242, the coordinate of the right eye image is calculated (Step S914). In the right eye image generating portion 252, the updated pixel of the right eye image is determined based on the calculated coordinate (Step S920), and then, the right eye image is updated (Step S915).

In the inner side loop, until the X coordinate reaches the maximum value Xₘₐₓ (Step S916), the variable i of the X coordinate is added by “1” (Step S917). If the X coordinate reaches the maximum value Xₘₐₓ, in the outer side loop, until the Y coordinate reaches the maximum value Yₘₐₓ (Step S918), the variable j of the Y coordinate is added by “1” (Step S919). If the Y coordinate reaches the maximum value Yₘₐₓ, the process on the one two-dimensional image 11 is ended.

In addition, Step S913 is an example of a depth setting procedure disclosed in the Claims. In addition, Step S914 is an example of a coordinate calculating procedure disclosed in the Claims. In addition, Steps S915 and S920 are examples of an image generating procedure disclosed in the Claims.

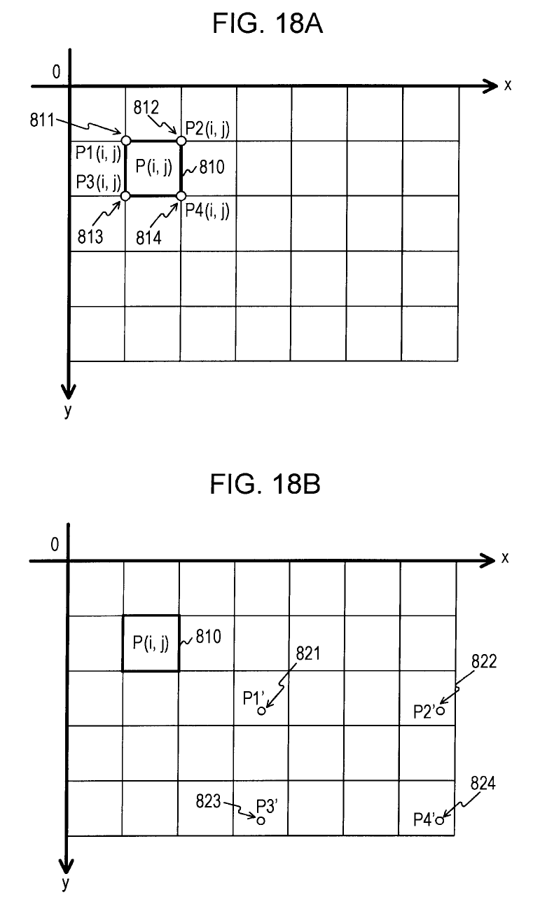

FIGS. 18A and 18B are diagrams illustrating an example of a right eye coordinate calculating process (Step S914) according to the first embodiment of the invention. As described with reference to FIG. 16, FIG. 18A illustrates neighboring coordinates 811 to 814 of the pixel 810 (P (i, j)). FIG. 18B illustrates after-transformation coordinates 821 to 824 with respect to the coordinates 811 to 814. As the after-transformation coordinates 821 to 824, the upper left coordinate 821 indicates P1′(i, j); the upper right coordinate 822 indicates P2′(i, j); the lower left coordinate 823 indicates P3′(i, j); and the lower right coordinate 824 indicates P4′(i, j).

For example, the X coordinate and the Y coordinate of the P1′(i, j) is expressed by Equations 4 and 5 as follows. In addition, in the case where the after-transformation coordinate exceeds a display area, the coordinate may be replaced by the coordinate of the display end portion.

x_{P1′(i, j)}=(L/(L−D))·x_{P1(i, j)}−(E·D)/(2·(L−D)

y_{P1′(i, j)}=y_{P1(i, j)}·L/(L−D)

Similarly, with respect to the P2′, P3′, and P4′, the coordinates are calculated.

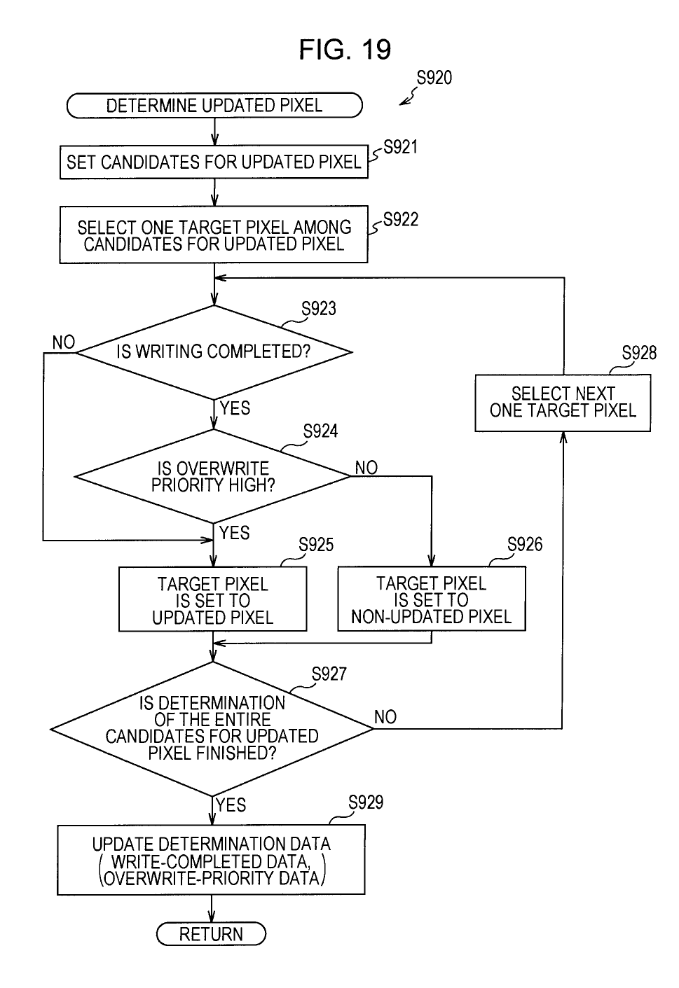

FIG. 19 is a diagram illustrating a processing procedure of a right eye image updated pixel determining process (Step S920) in the three-dimensional image generating device 200 according to the first embodiment of the invention. A to-be-updated pixel (hereinafter, referred to as an updated pixel) is determined according to the following procedures. In other words, all the candidates for the updated pixel are obtained, and the pixel which is to be overwritten is determined among the candidates. At this time, it is determined whether or not data have already been written. If data have already written, it is determined whether or not the pixel is to be overwritten. Next, a post process, determination data (later-described write-completed data and overwrite priority data) are updated.

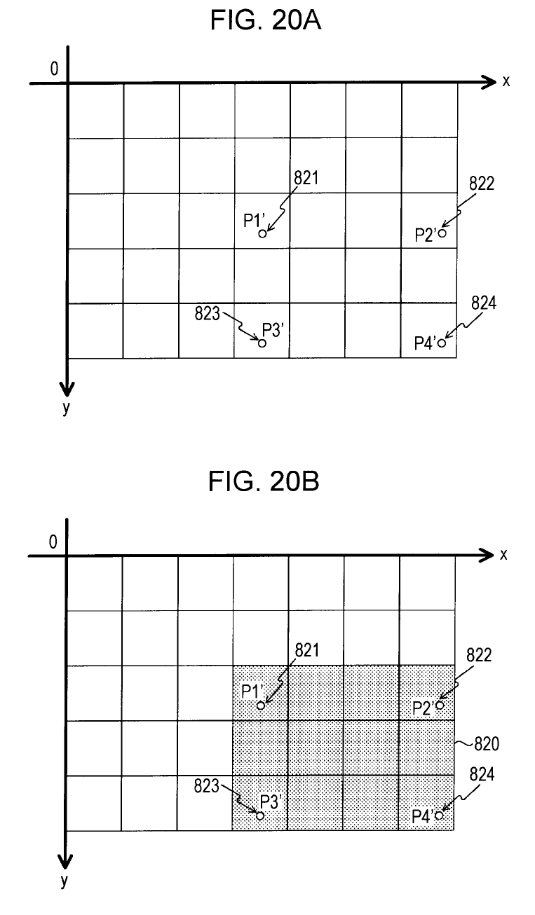

First, pixels contacting a rectangle connecting coordinates of after-transformation four points are set as candidates for the updated pixel (Step S921). For example, as illustrated in FIG. 20A, in the case where the coordinates 821 to 824 of the after-transformation four points are obtained, the pixels contacting the rectangle connecting the coordinates 821 to 824 are set as the candidates for the updated pixel. In FIG. 20B, the shaded portion corresponds to the candidates for the updated pixel.

Next, one target pixel is selected among the candidates for the updated pixel (Step S922). It is assumed that each pixel stores data indicating that the writing is completed. The target pixel (Step S923) which is not write-completed among the candidates for the updated pixel becomes the updated pixel (Step S925).

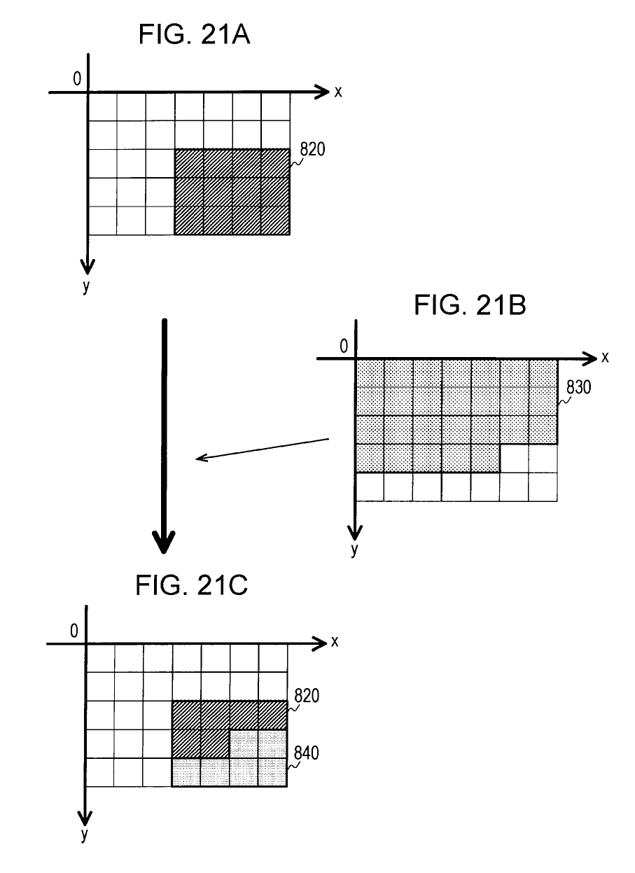

FIGS. 21A to 21C are diagrams illustrating a situation where the write-completion determination is performed. With respect to the candidates 820 for the updated pixel of FIG. 21A, in the case where the write-completed data 830 are retained as illustrated in FIG. 21B, the non-written updated pixels 840 which are non-written and updated are illustrated in FIG. 21C.

On the other hand, the following determination is further performed on the target pixel (Step S923) which is write-completed among the candidates for the updated pixel. It is assumed that each pixel stores data indicating the overwrite priority. The depth-degree information d(i, j) may be used as the overwrite priority. Therefore, as the depth-degree information, the data that are to exist at the foreground position is overwritten with priority, so that the data is finally displayed. Accordingly, a target pixel of which the overwrite priority is determined to be high (Step S924) becomes an updated pixel (Step S925). On the other hand, a target pixel of which the overwrite priority is determined not to be high (Step S924) becomes a non-updated pixel (Step S926).

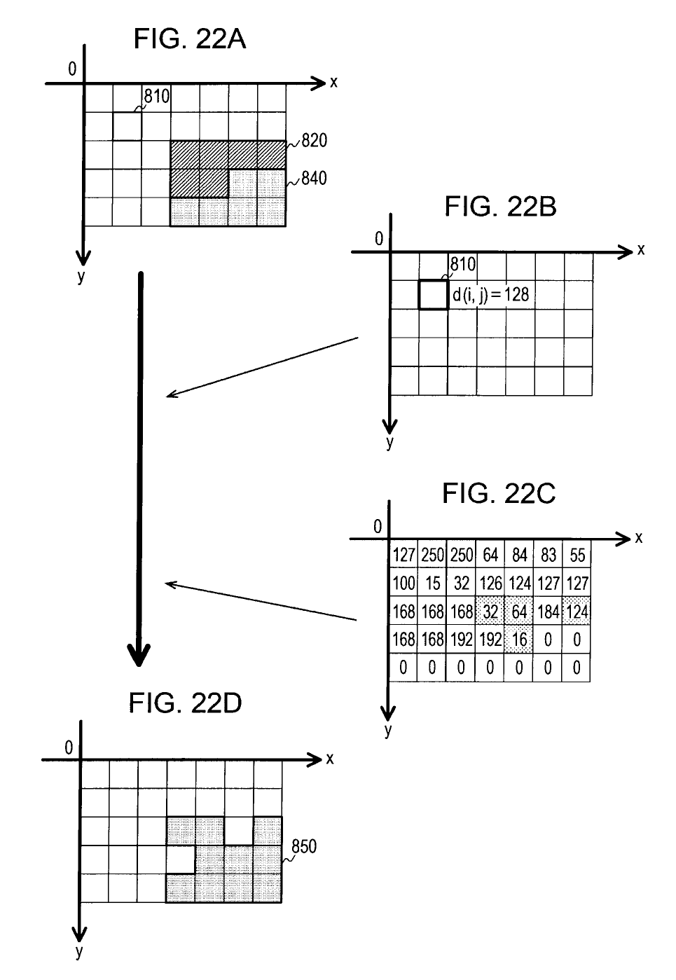

FIGS. 22A to 22D are diagrams illustrating a situation where the priority determination is performed. FIG. 22A is similar to FIG. 21C. As illustrated in FIG. 22B, it is assumed that the depth-degree information d(i, j) corresponding to the pixel 810 of the two-dimensional image 11 is “128”, and the value “128” is compared with the value which is written in the overwrite priority data of FIG. 22C. As a result, the shaded portion of FIG. 22C is the pixels which are determined as the pixels of which the overwrite priority is lower than that of the depth-degree information d(i, j) of the pixel 810 so as to be considered to be the updated pixels. In addition, the pixels that are indicated by “0” are the pixels in which the data are not yet written. Therefore, the updated pixels 850 are determined in combination of the non-written updated pixels 840.

Returning to FIG. 19, each of the candidates for the updated pixels is set as the target pixel, and the aforementioned determination is repeated (Step S928). The determination for all the candidates for the updated pixels is completed (Step S927), the write-completed data and the overwrite priority data are updated (Step S929). In addition, the write-completed data and the overwrite priority data are collectively referred to as determination data.

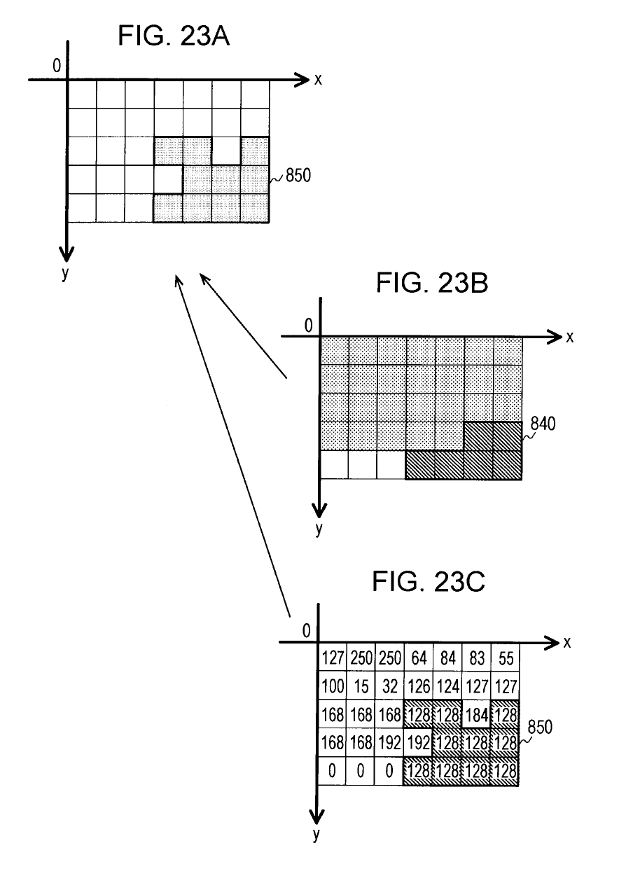

FIGS. 23A to 23C are diagrams illustrating a situation where the determination data updating is performed. FIG. 23A is similar to FIG. 22D. By determining the updated pixel 850, the write-completed data of FIG. 23B and the overwrite priority data of FIG. 23C are updated.

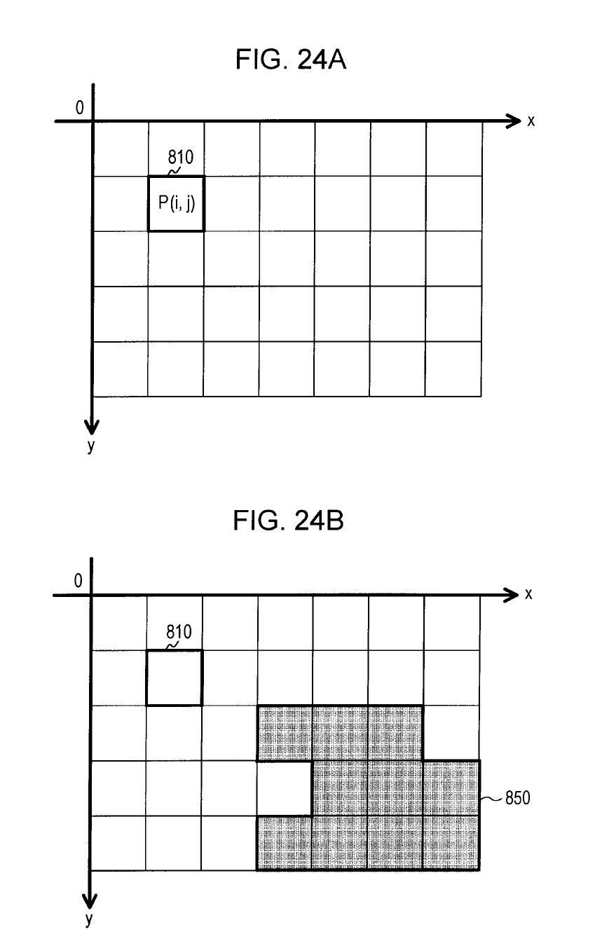

FIGS. 24A and 24B are diagrams illustrating an example of a right eye image updating process (Step S915) according to the first embodiment of the invention. The right eye image is updated by inserting the pixel value of the pixel 810 of the two-dimensional image 11 with respect to the updated pixels 850 of the right eye image determined by the hereinbefore process.

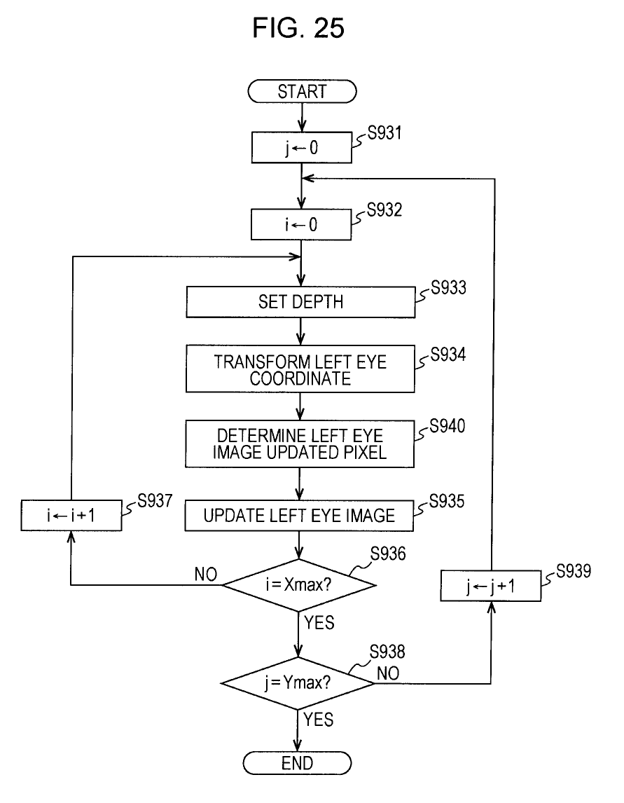

FIG. 25 is a diagram illustrating an example of a processing procedure of a left eye image generating process in the three-dimensional image generating device 200 according to the first embodiment of the invention. In the processing procedure of FIG. 17, the right eye image is generated, but in the processing procedure of this figure, the left eye image is generated. Although the coordinate transformation equation is different in that FIG. 3 and FIG. 6 are used, the basic process is the same as that of FIG. 17, the detailed description herein is omitted.

In addition, Step S933 is an example of a depth setting procedure disclosed in the Claims. In addition, Step S934 is an example of a coordinate calculating procedure disclosed in the Claims. In addition, Steps S935 and S940 are examples of an image generating procedure disclosed in the Claims.

In addition, although the aforementioned processing procedure according the embodiment of the invention uses the texture mapping, the invention is not limited thereto. For example, in the aforementioned example, although a method of performing the process pixel by pixel is exemplified, as other methods, there may be used a method of performing the process in the same framework by setting a plurality of pixels as one unit so as to reduce the amount of processing.

### [Situation of Stereoscopic View]

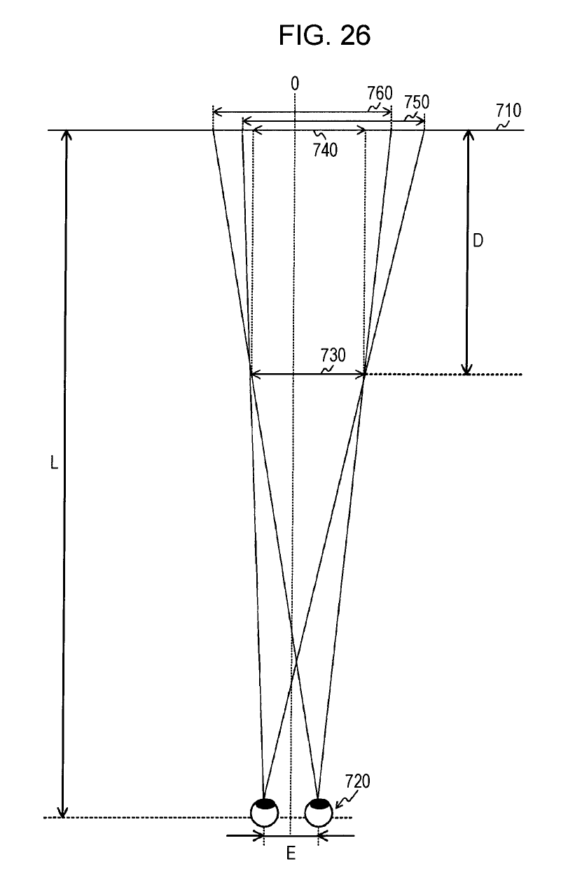

FIG. 26 is a diagram collectively illustrating the situations of the stereoscopic view generated according to the first embodiment of the invention. The object 740 is projected on the display plane 710 as an image 750 of the left eye image and an image 760 of the right eye image. In the case where the object 740 is viewed at the position of the viewing distance L from the display plane 710, the object 740 on the display plane 710 is formed as a stereoscopic view image 730 at the position with the depth D(xₚ, yₚ). The size of the object 740 is also maintained in the stereoscopic view image 730, and the image of the object 740 is formed to protrude or recede in the vertical direction in the state where the “size homeostasis” is secured.

In this manner, according to the first embodiment of the invention, it is possible to secure the “size homeostasis” when a three-dimensional image is generated from a two-dimensional image. Therefore, it is possible to appropriately improve the stereoscopic effect without applying of an excessive disparity, so that it is possible to reduce stress caused by the disparity.

### 2. Second Embodiment

In the second embodiment of the invention, the depth perceived by a viewer is emphasized by allowing the magnification ratio of the object to be allocated. In the second embodiment, since the entire configuration of the three-dimensional image display system is the same as that of the first embodiment described with reference to FIGS. 1 and 2, the description herein is omitted.

### [Example of Configuration of Three-Dimensional Image Display System]

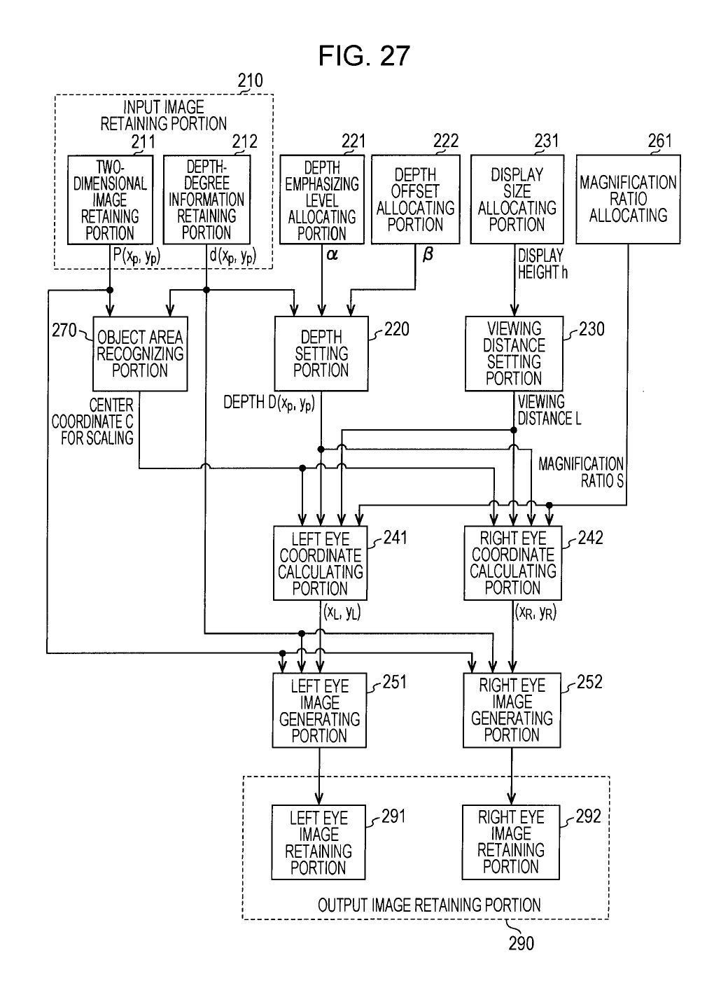

FIG. 27 is a diagram illustrating an example of a functional configuration of a three-dimensional image generating device 200 according to a second embodiment of the invention. The three-dimensional image generating device 200 according to the second embodiment is different from the configuration of the first embodiment in that a magnification ratio allocating portion 261 and an object area recognizing portion 270 are further included. The other configurations are the same. Accordingly, herein, description of the redundant portions is omitted.

The magnification ratio allocating portion 261 allocates a magnification ratio S which is a ratio of magnification of an object. The object of the two-dimensional image is formed at the position with the depth D(xₚ, yₚ) as a stereoscopic view image magnified according to the allocated magnification ratio S. The magnification ratio allocating portion 261 is implemented by the manipulation receiving portion 201.

The object area recognizing portion 270 recognizes an object area included in a two-dimensional image to extract the object and obtains a center coordinate C for scaling. Various methods may be used to recognize the object area. For example, it may be determined that pixels having close values of the depth-degree information d(xₚ, yₚ) are included in the same object area. In addition, it may be determined that pixels having close pixel values P(xₚ, yₚ) are included in the same object area.

### [Method of Calculating Left Eye Coordinate and Right Eye Coordinate]

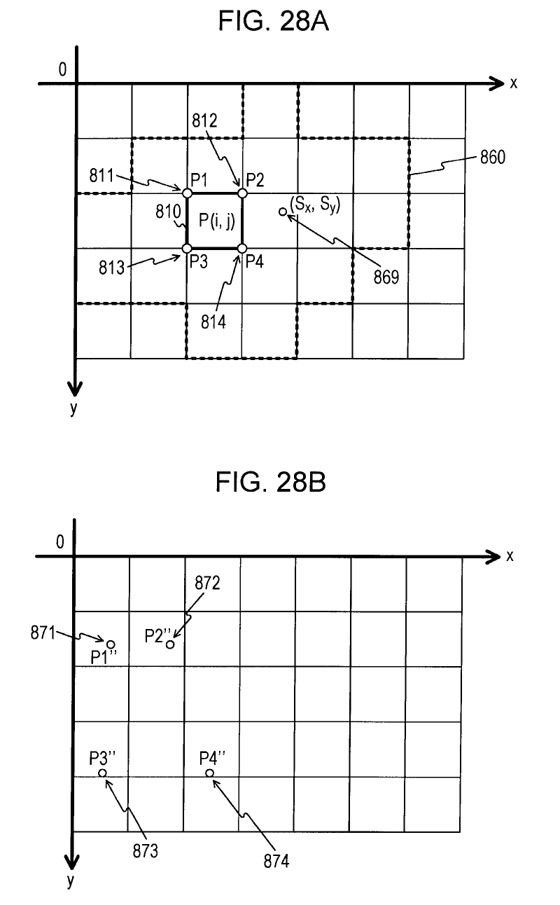

FIGS. 28A and 28B are diagrams illustrating an example of a right eye coordinate calculating process according to the second embodiment of the invention. As illustrated in FIG. 28A, if the object area 860 is recognized, the coordinate (Sₓ, S_{y}) of the center 869 of the object is obtained. Next, the center 869 is set as the center coordinate C, and the magnification is performed according to the magnification ratio S, so that the coordinates 811 to 814 are transformed into the coordinates 871 to 874. in FIG. 28B, the after-transformation coordinates 871 to 874 of the coordinates 811 to 814 are illustrated. With respect to the after-transformation coordinates 871 to 874, the upper left coordinate 871 is denoted by P1″ (i, j); the upper right coordinate 872 is denoted by P2″ (i, j); the lower left coordinate 873 is denoted by P3″ (i, j); and the lower right coordinate 874 is denoted by P4″ (i, j). The transformation equation according to the second embodiment will be described later.

In addition, in the example of the figure, although the right eye coordinate calculating process is described, since the same description may also be made on the left eye coordinate calculating process, the description herein is omitted.

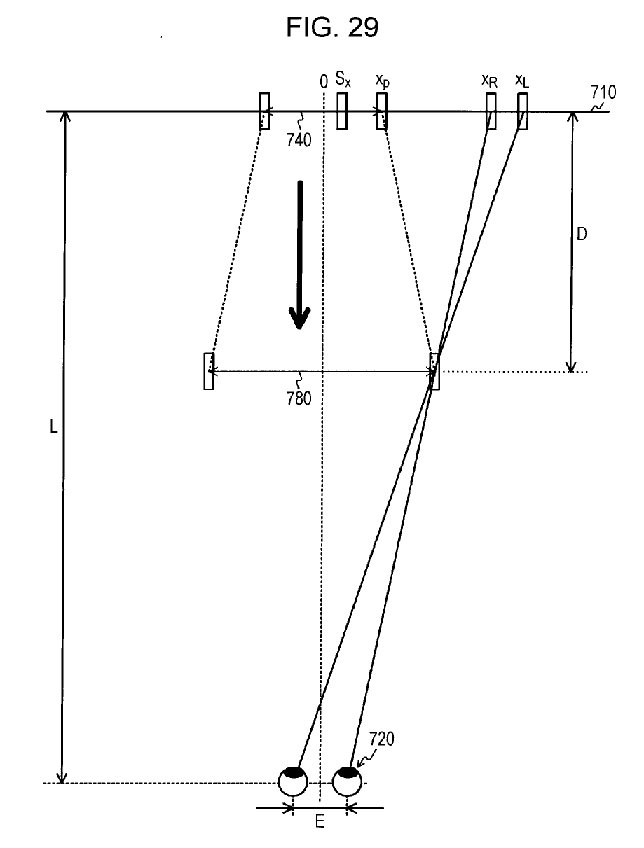

FIG. 29 is a top view illustrating a method of calculating X coordinates of a left eye image and a right eye image according to the second embodiment of the invention. In the second embodiment, similarly to the aforementioned first embodiment, it is assumed that the two eyes 720 are located at the position of the viewing distance L from the display plane 710. The viewing distance L is set to a value which is three times a display height h by the viewing distance setting portion 230. For the eye distance E, for example, 65 mm may be used as a standard value. In addition, the depth D(xₚ, yₚ) from the display plane 710 may be obtained from the aforementioned Equation 1 or 2 by the depth setting portion 220. However, therefore, in the viewing distance L, the object 780 is recognized as the stereoscopic view image 730 at the position which protrudes in the vertical direction with the depth D(xₚ, yₚ). However, since the size of the object 780 becomes the size of the object 740 multiplied by the magnification ratio S, the distance in the X coordinate direction also becomes the size multiplied by the magnification ratio S.

Hereinafter, a transformation equation of the case where a corner of the object 740 is set as the observed pixel (xₚ, yₚ) and the X coordinate xₚ is transformed into the coordinate x_{L} on the left eye image and the coordinate x_{R} on the right eye image is described.

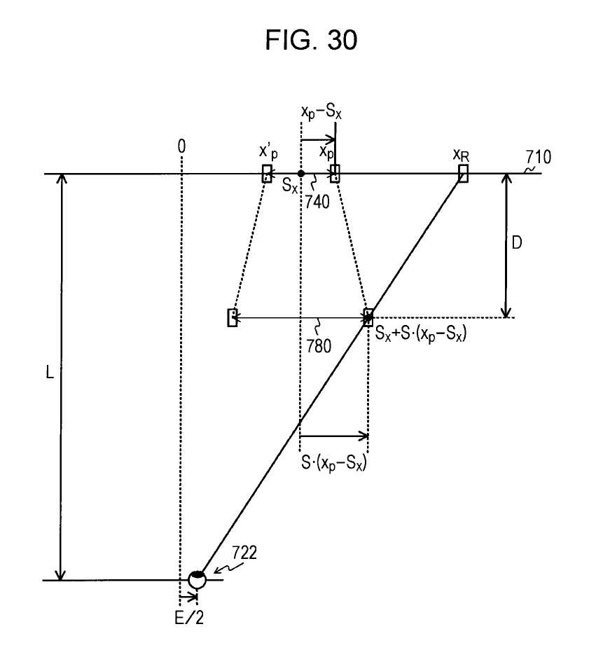

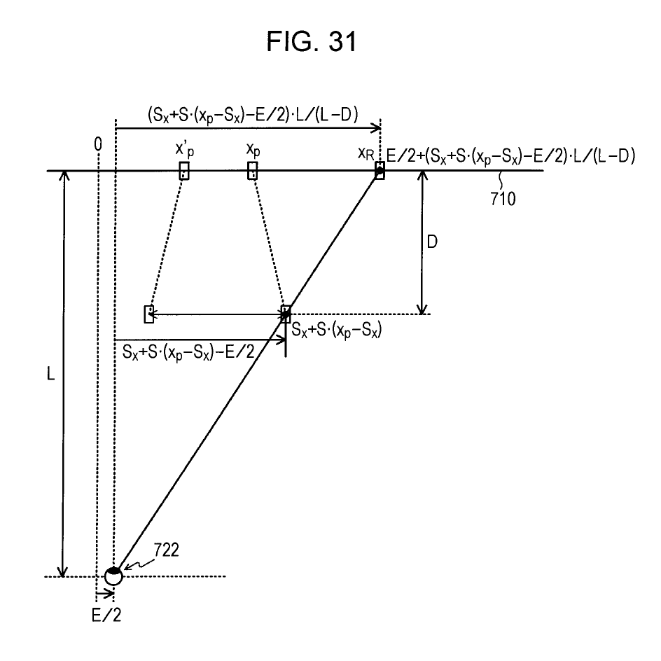

FIGS. 30 and 31 are top views illustrating methods of calculating X coordinates of a right eye image according to the second embodiment of the invention.

First, as illustrated in FIG. 30, if the X coordinate of the center coordinate C of the object 740 extracted by the object area recognizing portion 270 is denoted by Sₓ, a distance between the center coordinate Sₓ and the coordinate xₚ of the right corner of the object 740 becomes “xₚ−Sₓ”. Since the distance is magnified by the magnification ratio S at the depth D, the coordinate of the right corner of the object 780 becomes “Sₓ+S·(xₚ−Sₓ)”.

Since the center between the two eyes is set as the origin in the X coordinate direction in this coordinate system, as illustrated in FIG. 31, if an auxiliary line extending from the right eye in the vertical direction with respect to the display plane, the following equation is satisfied for a triangle defined by the X coordinate x_{R} of the right eye image corresponding to the X coordinate xₚ of the observed pixel and the right eye 722.

L:(x_{R}−E/2)=(L−D):(Sₓ+S·(xₚ−Sₓ)−E/2)

If the above equation is solved with respect to the x_{R}, the following equation is obtained.

x_{R}=(E/2)+(Sₓ+S·(xₚ−Sₓ)−E/2)·L/(L−D)

In addition, by using the same calculation method, the X coordinate x_{L} of the left eye image corresponding to the X coordinate xₚ of the observed pixel is expressed by the following Equation.

x_{L}=(−E/2)+(Sₓ+S·(xₚ−Sₓ)+E/2)·L/(L−D)

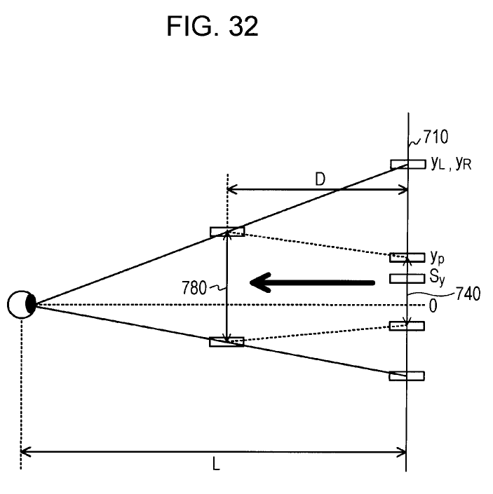

FIG. 32 is a side view illustrating a method of calculating Y coordinates of a left eye image and a right eye image according to the second embodiment of the invention. The same viewing distance L or depth D(xₚ, yₚ) is used as that of the case of calculating the X coordinate. In other words, in the viewing distance L, the object 740 is recognized as the stereoscopic view image 780 at the position which protrudes in the vertical direction with the depth D(xₚ, yₚ). However, since the size of the object 780 becomes the size of the object 740 multiplied by the magnification ratio S, the distance in the Y coordinate direction also becomes the size multiplied by the magnification ratio S.

Hereinafter, a transformation equation of the case where a corner of the object 740 is set as the observed pixel (xₚ, yₚ) and the Y coordinate yₚ is transformed into the coordinate y_{L} on the left eye image and the coordinate y_{R} on the right eye image is described. However, unlike the X coordinate, since the Y coordinates of the left eye image and the right eye image are coincident with each other, the description is made on the coordinate y_{R} of the right eye image.

First, if the Y coordinate of the center coordinate C of the object 740 extracted by the object area recognizing portion 270 is denoted by S_{y}, a distance between the center coordinate S_{y} and the coordinate yₚ of the right corner of the object 740 becomes “yₚ−S_{y}”. Since the distance is magnified by the magnification ratio S at the depth D, the coordinate of the right corner of the object 780 becomes “S_{y}+S·(yₚ−S_{y})”.

If auxiliary lines extending from the centers of the two eyes in the vertical direction with respect to the display plane are considered, the following equation is satisfied for a triangle defined by the Y coordinate y_{R} of the right eye image corresponding to the Y coordinate yₚ of the observed pixel and the two eyes 720.

L:y_{R}=(L−D):(S_{y}+S·(yₚ−S_{y}))

If the above equation is solved with respect to the y_{R}, the following equation is obtained.

y_{R}=(S_{y}+S·(yₚ−S_{y}))·L/(L−D)

### [Situation of Stereoscopic View]

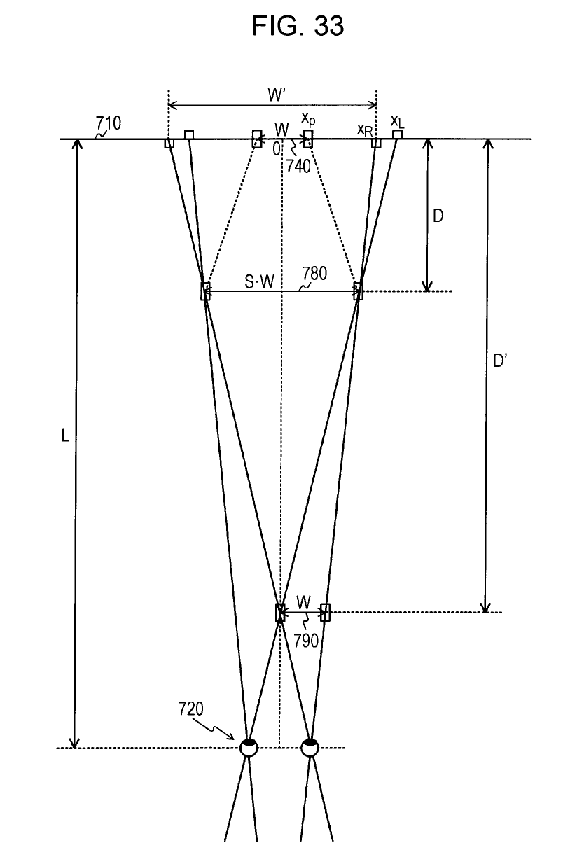

FIG. 33 is a diagram collectively illustrating the situations of the stereoscopic view generated according to the second embodiment of the invention. In the case where the object 740 having a width W in the X coordinate direction is viewed at the position of the viewing distance L from the display plane 710 is formed as the stereoscopic view image 780 having a width S·W at the position with the depth D(xₚ, yₚ) in the display plane 710. The width of an image of the right eye image corresponding to the object 740 at this time is W′ which is larger than W.

In order to compare with the first embodiment, a position of the stereoscopic view image 790 having a width W is illustrated in the same figure. The position of the stereoscopic view image 790 becomes a perceived depth D′ of the viewer. In other words, according to the second embodiment, it is possible to improve the stereoscopic effect perceived by the viewer according to the allocated magnification ratio S. In order to emphasize the depth, as described with reference to FIGS. 13A, 13B, 14A and 14B, although the depth D may be set according to the depth emphasizing level α allocated by the depth emphasizing level allocating portion 221, the improvement of the stereoscopic effect according to the magnification ratio S is different in terms of the structure. Hereinafter, the improvement of the stereoscopic effect by using the magnification ratio S will be described.

The perceived depth D′ is expressed by using the depth D, the viewing distance L, and the magnification ratio S according to the following Equation.

D′=(L·(S−1)+D)/S

Herein, if the disparity DP according to the second embodiment is calculated, the disparity DP is expressed by using the depth D, the viewing distance L, and the eye distance E according to the following Equation.

DP=(E·D)/(L−D)

On the contrary, the disparity DP′ from which the perceived depth D′ may be obtained is expressed according to the following Equation.

DP′=(E·D′)/(L−D′)=E·(L·(S−1)+D)/(S·L−(L·(S−1)+D))

For example, if the magnification ratio S is set to “2”, if the viewing distance L is set to “1.7 m”, if the depth D is set to “0.5 m”, and if the eye distance E is set to “65 mm”, the disparity DP according to the second embodiment becomes “27 mm”. By comparing this result with the disparity DP′ of “119 mm” of the first embodiment corresponding to the case where the magnification ratio S is set to “1”, the disparity is suppressed down to about ¼ times while the apparent size of the retinal image is maintained to be equal. In this manner, according to the second embodiment, it is possible to reduce stress to a viewer caused by the disparity.

In addition, the embodiments of the invention provides examples for implementing the invention, and as clarified in the embodiments of the invention, the elements in the embodiments of the invention have correspondence relationship with the features specifying the invention in claims. Similarly, the features specifying the invention in claims have correspondence relationship with the elements in the embodiments of the invention denoted by the same terms. However, the invention is not limited to the embodiments, but various modifications of the embodiments may be implemented without departing from the spirit of the invention.

In addition, the processing procedures described in the embodiments of the invention may be considered to be methods having a series of the procedures and may be considered to be a program for allowing a computer to execute a series of the procedures or a recording medium storing the program. As the recording medium, for example, a CD(Compact Disc), an MD(MiniDisc), a DVD(Digital Versatile Disc), a memory card, a Blu-ray Disc (registered trade mark), or the like may be used.

The present application contains subject matter related to that disclosed in Japanese Priority Patent Application JP 2009-297765 filed with the Japan Patent Office on Dec. 28, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A three-dimensional image generating device comprising:
a depth setting portion configured to set a depth of each pixel or pixel group of a two-dimensional image, from which a stereoscopic view image is formed, from depth-degree information indicating a depth degree of each pixel or pixel group of the two-dimensional image;
a coordinate calculating portion configured to calculate coordinates of a left eye image and a right eye image of a three-dimensional image on a display plane corresponding to each pixel or pixel group of the two-dimensional image from the depth and a distance from the display plane to a viewing position; and
an image generating portion configured to generate the left eye image and the right eye image corresponding to the two-dimensional image according to the calculated coordinates.

2. The three-dimensional image generating device according to claim 1, further comprising an object area recognizing portion configured to recognize an object area in the two-dimensional image based on the two-dimensional image and the depth-degree information and generate coordinates of the center of the object area as a center coordinate,
wherein the coordinate calculating portion calculates the coordinates of the left eye image and the right eye image corresponding to each pixel and pixel group of the object area so that the stereoscopic view image is formed by magnifying the object area with respect to the center coordinate as a reference according to an allocated magnification ratio.

3. The three-dimensional image generating device according to claim 1, wherein the coordinate calculating portion includes:
a shift amount calculating portion configured to calculate shift amounts of the left eye image and the right eye image in the X coordinate and the Y coordinate with respect to the two-dimensional image; and
a coordinate position calculating portion configured to calculate coordinate positions in the X coordinate and Y coordinate based on the shift amount.

4. The three-dimensional image generating device according to claim 1, wherein the depth setting portion sets a value increased or decreased by an allocated depth offset in proportion to an allocated depth emphasizing level as the depth.

5. A three-dimensional image display device comprising:
a depth setting portion configured to set a depth of each pixel or pixel group of a two-dimensional image, from which a stereoscopic view image is formed, from depth-degree information indicating a depth degree of each pixel or pixel group of the two-dimensional image;
a coordinate calculating portion configured to calculate coordinates of a left eye image and a right eye image of a three-dimensional image on a display plane corresponding to each pixel or pixel group of the two-dimensional image from the depth and a distance from the display plane to a viewing position;
an image generating portion configured to generate the left eye image and the right eye image corresponding to the two-dimensional image according to the calculated coordinates; and
an image display portion configured to display a three-dimensional image using the left eye image and the right eye image.

6. A three-dimensional image generating method comprising the steps of:
setting a depth of each pixel or pixel group of a two-dimensional image, from which a stereoscopic view image is formed, from depth-degree information indicating a depth degree of each pixel or pixel group of the two-dimensional image;
calculating coordinates of a left eye image and a right eye image of a three-dimensional image on a display plane corresponding to each pixel or pixel group of the two-dimensional image from the depth and a distance from the display plane to a viewing position; and
generating the left eye image and the right eye image corresponding to the two-dimensional image according to the calculated coordinates.

7. A program allowing a computer to execute the steps of:
setting a depth of each pixel or pixel group of a two-dimensional image, from which a stereoscopic view image is formed, from depth-degree information indicating a depth degree of each pixel or pixel group of the two-dimensional image;
calculating coordinates of a left eye image and a right eye image of a three-dimensional image on a display plane corresponding to each pixel or pixel group of the two-dimensional image from the depth and a distance from the display plane to a viewing position; and
generating the left eye image and the right eye image corresponding to the two-dimensional image according to the calculated coordinates.
